(19) United States
(12) Patent Application Publication
(10) Pub. No.: US 2023/0416088 A1
(43) Pub. Date: Dec. 28, 2023

(54) CATALYST FOR CARBONYL SULFIDE REMOVAL FROM HYDROCARBONS

(71) Applicant: Merichem Company, Houston, TX (US)

(72) Inventors: Zhouyang Liu, Houston, TX (US); Nachiketa Anand, Houston, TX (US); Jeff Gomach, Houston, TX (US)

(73) Assignee: Merichem Company, Houston, TX (US)

(21) Appl. No.: 17/851,759

(22) Filed: Jun. 28, 2022

(51) Int. Cl. C01B 17/16; B01J 31/02; B01J 35/02; B01J 37/02

(52) U.S. Cl. CPC C01B 17/165; B01J 31/0238; B01J 2208/027; B01J 37/0217; B01J 37/0219; B01J 35/026

(57) ABSTRACT

A method may include: contacting a feed stream comprising carbonyl sulfide with an aqueous stream comprising water in the presence of a carbonyl sulfide hydrolysis catalyst, wherein the carbonyl sulfide hydrolysis catalyst comprises a solid support and a polyamine covalently bonded to the solid support; and hydrolyzing at least a portion of the carbonyl sulfide to produce at least hydrogen sulfide.

### BACKGROUND

Carbonyl sulfide (COS) is a contaminant found in many chemical plant and refinery streams. Carbonyl sulfide can be produced as a side product in synthesis of carbon disulfide as well in several other industries such as in power plants, coking units, biomass combustion units, petroleum refining, rubber manufacture, and synthetic fiber manufacturing, for example. Carbonyl sulfide can hydrolyze to form hydrogen sulfide and carbon dioxide which can cause product streams to become off specification or cause operational hazards due to the presence of the hydrogen sulfide. Oftentimes, carbonyl sulfide contaminated streams are treated to remove at least a portion of the carbonyl sulfide.

Amine treatment has been used to remove carbonyl sulfide. A carbonyl sulfide containing stream is contacted with a suitable amine in a contacting vessel to react the carbonyl sulfide with the amine. The reaction can form heat stable salts and other non-regenerable degradation products requiring use of a reclaimer to regenerate the amine. Further, the reaction is slow and may require long residence times to remove carbonyl sulfide to acceptable levels.

Non-regenerative absorbents have also been used to remove carbonyl sulfide. In such embodiments, a carbonyl sulfide containing stream is passed through a bed of adsorbent material which absorbs the carbonyl sulfide. The absorbent materials are typically based on copper or zinc oxide and have limited lifetime which depends on the level of contaminants in the carbonyl sulfide containing stream.

Regenerative adsorption of carbonyl sulfide can also be accomplished using an adsorbent media such as molecular sieves or activated alumina. However, the efficacy of adsorption is low due to the shape of carbonyl sulfide limiting the amount of adsorption. Further, the adsorbent media can form carbonyl sulfide from catalytic reactions during cycling which usually prohibits complete removal of carbonyl sulfide. A sweep gas is usually required for regeneration of the adsorbent media. Hydrogen sulfide can be produced during adsorption and regeneration which can complicate operations by requirement to treat a sour sweep gas.

Carbonyl sulfide can also be removed by hydrolysis to produce carbon dioxide and hydrogen sulfide. Carbonyl sulfide hydrolysis units can utilize a hydrolysis catalyst to promote the hydrolysis reaction. One main disadvantage of hydrolysis is the generation of sour gasses which typically must be removed downstream.

While each of the methods of treating carbonyl sulfide contaminated streams can be optimized to some degree, there may be limitations to each approach such as requiring additional equipment or creating additional hazards such as production of hydrogen sulfide.

### SUMMARY

Disclosed herein is an example method including: contacting a feed stream comprising carbonyl sulfide with an aqueous stream comprising water in the presence of a carbonyl sulfide hydrolysis catalyst, wherein the carbonyl sulfide hydrolysis catalyst comprises a solid support and a polyamine covalently bonded to the solid support; and hydrolyzing at least a portion of the carbonyl sulfide to produce at least hydrogen sulfide.

Further disclosed herein is a method including: introducing carbonyl sulfide and an aqueous liquid into a vessel comprising a carbonyl sulfide hydrolysis catalyst; and hydrolyzing at least a portion of the carbonyl sulfide to produce at least hydrogen sulfide; wherein the carbonyl sulfide hydrolysis catalyst comprises a solid support and a polyamine covalently bonded to the solid support and wherein the vessel comprises at least one of a distillation column, a contacting tower, or a fiber bundle type liquid-liquid contactor.

Further disclosed herein is a method of producing a carbonyl sulfide hydrolysis catalyst including: providing a solid support comprising an oxygen containing functional group; mixing the solid support with a polyamine; and reacting at least a portion of the polyamine with the solid support to form a covalent bond between the polyamine and the solid support, thereby forming the carbonyl sulfide hydrolysis catalyst.

These and other features and attributes of the disclosed processes and systems of the present disclosure and their advantageous applications and/or uses will be apparent from the detailed description which follows.

### BRIEF DESCRIPTION OF THE DRAWINGS

These drawings illustrate certain aspects of some of the embodiments of the present disclosure, and should not be used to limit or define the disclosure.

FIG. 1 is a schematic illustration of an embodiment of a fiber-bundle type liquid-liquid mass transfer device.

FIG. 2 is a schematic illustration of an embodiment of a packed-column type liquid-liquid mass transfer device.

FIG. 3 is a schematic illustration of an embodiment of a distillation column.

### DETAILED DESCRIPTION

The present disclosure relates to carbonyl sulfide hydrolysis catalysts, and in some embodiments, methods of using carbonyl sulfide hydrolysis catalysts to remove carbonyl sulfide from a process stream. Further embodiments include liquid-liquid mass transfer devices comprising carbonyl sulfide hydrolysis catalysts and methods of removing carbonyl sulfide from process streams using liquid-liquid mass transfer devices. The carbonyl sulfide hydrolysis catalysts may comprise a solid support and a polyamine covalently bonded to the solid support.

The balanced reaction for hydrolysis of carbonyl sulfide is shown in Reaction 1 where carbonyl sulfide is reacted with water to produce carbon dioxide and hydrogen sulfide. The catalytic hydrolysis of carbonyl sulfide is a first-order reaction with respect to carbonyl sulfide and the reaction order of water changes as the reaction condition changes. The hydrolysis of carbonyl sulfide is base-catalyzed reaction, and the basicity of the catalyst has an important effect on the hydrolysis of carbonyl sulfide. The carbonyl sulfide hydrolysis catalyst, due to the polyamine covalently bonded to the support provides the basic conditions to catalyze the hydrolysis reaction. As will be discussed in further detail below, the water in reaction 1 can be provided by an aqueous hydrogen sulfide scavenger solution. After the hydrogen sulfide is produced in Reaction 1, the hydrogen sulfide scavenger from the aqueous hydrogen sulfide scavenger solution will react with the hydrogen sulfide to produce a reaction product thereby removing the hydrogen sulfide from solution. When the aqueous hydrogen sulfide scavenger solution includes caustic such as sodium hydroxide, the sodium hydroxide can react with the hydrogen sulfide as shown in Reaction 2 to produce water and sodium hydrosulfide.

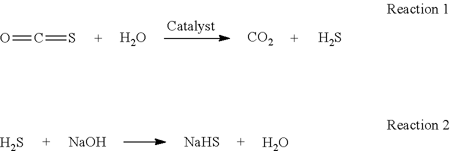

A proposed mechanism for the catalytic reaction of carbonyl sulfide is shown in Reactions 3-5.

COS+Amine+H₂O↔AmineH⁺+HCO₂S⁻ Reaction 3

HCO₂S⁻+Amine+H₂O↔AmineH⁺+HS⁻+HCO₃⁻ Reaction 4

AmineH⁺+NaOH↔Amine+Na⁺+H₂O Reaction 5

Using carbonyl sulfide hydrolysis catalysts as described above to remove carbonyl sulfide from process streams has many advantages over conventional methods for removing carbonyl sulfide, only some of which may be alluded to herein. For example, in using carbonyl sulfide hydrolysis catalysts and aqueous hydrogen sulfide scavenger solution, no additional hydrogen sulfide treatment is necessary and no amine containing liquid waste is generated nor are additional amine regeneration processes required.

As mentioned above, carbonyl sulfide hydrolysis catalysts may comprise a solid support and a polyamine covalently bonded to the solid support. The solid support can include any solid material which has oxygen-containing functional groups which are covalently bonded to at least a portion of the surface of the solid support. Some suitable oxygen-containing functional groups include, without limitation, carboxyl, carbonyl, lactone, hydroxyl, and combinations thereof. In some embodiments, the solid support can be modified to include oxygen-containing functional groups disposed on the surface. As will be discussed in further detail below, there are several methods to graft the polyamine to the solid support by reacting the oxygen-containing functional group with the polyamine. The support should be stable at operating conditions for performing the carbonyl sulfide hydrolysis reaction and be resistant to degradation by process fluids. Solid supports can have any suitable morphology such as bead, pellet, toroidal, and the like which may be particularly suitable in embodiments where the carbonyl sulfide hydrolysis catalyst is incorporated in a catalyst bed. In further embodiments the solid support is in the form of a fiber which can be incorporated into a fiber bundle and may be particularly suitable for use in fiber bundle type liquid-liquid contactors. Some suitable supports include, without limitation, activated carbon fiber, carbon fiber, nylon, rayon, polyesters, polyolefins, polytetrafluoroethylene, silica, titanium dioxide, aluminum oxide, glass, fiberglass, and combinations thereof.

Any type of carbon fiber may be utilized in the present disclosure including, but not limited to, carbon fibers prepared using polyacrylonitrile (PAN), mesophase pitch, and rayon. Suitable carbon fibers may have any structural ordering including those carbon fibers classified as turbostratic or graphitic or any structural ordering therebetween. Carbon fibers may be of any quality including from about 50% carbon by weight to about 100% carbon by weight any may have any classification such as low modulus carbon fiber having a tensile strength modulus below 240 million kPa, intermediate modulus carbon fiber having a tensile strength modulus of about 240 million kPa to 500 million kPa, or high tensile strength modulus carbon fiber having a tensile strength modulus of about 500 million-1.0 billion kPa. Carbon fibers may have any diameter including from about 5 micrometers to about 20 micrometers, or any diameters therebetween. Carbon fibers may be in the form of yarns or bundles whereby several hundred to several thousand individual carbon fibers may be spun together to form the carbon fiber yarn or carbon fiber bundle.

Carbonyl sulfide hydrolysis catalysts may be prepared by reacting the oxygen-containing functional groups on the solid support with a polyamine to form a covalent bond such as an amide bond between the solid support and the polyamine. There are several synthesis methods for formation of an amide bond between the solid support and the polyamine, only some of which may be disclosed herein. One synthesis method may include direct formation of the amide bond by reacting the solid support and polyamine at elevated temperature in a suitable solvent. Another synthesis method may include amide formation via the generation of acyl chlorides from carboxylic acids with chlorinating agents such as thionyl chloride. Another synthesis method may include amide formation using a coupling agent such as carbodiimide or benzotriazole. Another synthesis method may include enzyme catalyzed amide formation.

The polyamine can include any amine compound with 2 amine groups including diamines, triamines, and higher order amines. The amine containing compound may include linear, branched, or cyclic primary or secondary amines, with carbon numbers ranging from C2-C20. Some specific amine containing compounds may include, without limitation, ethylenediamine, propane-1,3-diamine, butane-1,4-diamine, pentane-1,5-diamine, hexamethylenediamine, diethylenetriamine, benzene-1,3,5-triamine, polyethyleneimine (PEI), and combinations thereof.

In the direct amide bond synthesis, the solid support containing oxygen-containing functional groups and polyamine may be combined in a solvent and heated thereby forming an amide bond between the oxygen-containing functional groups and polyamine to produce the carbonyl sulfide hydrolysis catalyst. Some suitable solvents may include, but are not limited to pyridine, DMSO, DMF, THF, ethanol, acetonitrile, chloroform, ethylene glycol, methanol, benzene, and combinations thereof. The solid support may be reacted with the polyamine at any suitable conditions, including at a temperature in the range of about 100° C. to 200° C. Alternatively, the reaction may be performed in a range of 100° C. to about 125° C., about 125° C. to about 150° C., about 150° C. to about 175° C., about 175° C. to about 200° C., or any temperature ranges therebetween. The time required for reacting the solid support and polyamine may be dependent upon many factors including identity of the aminated macrocycle and temperature conditions selected. In general, the solid support may be reacted with the aminated macrocycle for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hours, about 12 hours to about 15 hours, about 15 hours to about 18 hours, about 18 hours to about 21 hours, about 21 hours to about 24 hours, or any ranges therebetween. After the reaction to form the carbonyl sulfide hydrolysis catalyst, the carbonyl sulfide hydrolysis catalyst may optionally be washed using water or other solvent to remove excess polyamine. The carbonyl sulfide hydrolysis catalyst may be dried at elevated temperature after washing to remove water or solvent used in the washing step.

In the acyl chloride synthesis, the solid support containing oxygen-containing functional groups may be combined with a chlorinating agent such as thionyl chloride, phosphorous trichloride, or terephthaloyl chloride, and heated. The chlorinating agent may react with oxygen containing groups, such as carboxylic groups, on the solid support to produce acyl chloride on the solid support. The solid support may be reacted with the chlorinating agent at any suitable conditions below the boiling point of the chlorinating agent, including at a temperature in the range of about 0° C. to 150° C. Alternatively, the reaction may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. In general, the solid support may be reacted with the chlorinating agent for a period of time ranging from about 1 hour to about 24 hours or longer. The chlorinating agent modified solid support may be reacted with a polyamine to produce the carbonyl sulfide hydrolysis catalyst. For example, the chlorinating agent modified solid support and polyamine may be combined in a solvent and heated thereby forming an amine bond between the solid support and polyamine to produce the carbonyl sulfide hydrolysis catalyst. Some suitable solvents may include, but are not limited to water, pyridine, DMSO, DMF, THF, ethanol, acetonitrile, chloroform, ethylene glycol, methanol, benzene, and combinations thereof. The chlorinating agent modified solid support may be reacted with the polyamine at any suitable conditions, including at a temperature in the range of about 0° C. to 150° C. Alternatively, the reaction may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. The time required for reacting the chlorinating agent modified solid support and polyamine may be dependent upon many factors including identity of the polyamine and temperature conditions selected. In general, the chlorinating agent modified solid support may be reacted with the polyamine for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hour, about 12 hours to about 15 hours, about 15 hours to about 18 hours, about 18 hours to about 21 hours, about 21 hours to about 24 hours, or any ranges therebetween. After the reaction with the polyamine, the carbonyl sulfide hydrolysis catalyst may optionally be washed using water or other solvent to remove excess polyamine. The carbonyl sulfide hydrolysis catalyst may be dried at elevated temperature after washing to remove water or solvent used in the washing step.

Another synthesis method of the carbonyl sulfide hydrolysis catalyst may include amide formation using a coupling agent. In this method, solid support and a coupling agent may be combined in a suitable solvent and heated. The coupling agent may react with oxygen-containing functional groups on the solid support or with the solid support itself to form a functionalized solid support. Some suitable coupling agents may include, but are not limited to carbodiimide, benzotriazole, and combinations thereof. The functionalized solid support may be combined with a polyamine and solvent which may then react to form the carbonyl sulfide hydrolysis catalyst. Some suitable solvents may include, but are not limited to water, pyridine, DMSO, DMF, THF, ethanol, acetonitrile, chloroform, ethylene glycol, methanol, benzene, and combinations thereof. The functionalized solid support may be reacted with the polyamine at any suitable conditions, including at a temperature in the range of about 0° C. to 150° C. Alternatively, the reaction may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. The time required for reacting the functionalized solid support and polyamine may be dependent upon many factors including identity of the polyamine and temperature conditions selected. In general, the functionalized solid support may be reacted with the polyamine for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hour, about 12 hours to about 15 hours, about 15 hours to about 18 hours, about 18 hours to about 21 hours, about 21 hours to about 24 hours, or any ranges therebetween. After the polyamine reaction, the carbonyl sulfide hydrolysis catalyst may optionally be washed using water or other solvent to remove excess polyamine. The carbonyl sulfide hydrolysis catalyst may be dried at elevated temperature after washing to remove water or solvent used in the washing step.

Another synthesis method may include amide formation using an enzyme. Enzymatic catalysis may allow for the amination reaction to occur at relatively lower temperatures which may allow for a broader solvent compatibility. In this method, solid support and polyamine may be combined in a in a suitable solvent with an enzyme. The enzyme may include any enzyme capable of catalyzing the formation of an amide bond between the carbon fiber and the animated macrocycle. Some examples of suitable enzymes may include, but are not limited to, proteases, subtilisin, acylases, amidases lipases, and combinations thereof. Some suitable solvents may include, but are not limited to water, pyridine, DMSO, DMF, THF, ethanol, acetonitrile, chloroform, ethylene glycol, methanol, benzene, and combinations thereof. The solid support may be reacted with the polyamine at any suitable conditions, including at a temperature in the range of about 0° C. to 100° C. Alternatively, the reaction may be performed in a range of 0° C. to about 25° C., about 25° C. to about 50° C., about 50° C. to about 75° C., about 75° C. to about 100° C., or any temperature ranges therebetween. The time required for reacting the solid support and polyamine may be dependent upon many factors including identity of the polyamine and temperature conditions selected. In general, the solid support may be reacted with the polyamine for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hours, about 12 hours to about 15 hours, about 15 hours to about 18 hours, about 18 hours to about 21 hours, about 21 hours to about 24 hours, or any ranges therebetween. After the polyamine reaction, the carbonyl sulfide hydrolysis catalyst may optionally be washed using water or other solvent to remove excess polyamine. The carbonyl sulfide hydrolysis catalyst may be dried at elevated temperature after washing to remove water or solvent used in the washing step.

As mentioned above, the solid support can include any solid material which has oxygen-containing functional groups which are covalently bonded to at least a portion of the surface of the solid support. Some suitable solid supports, such as carbon fibers, can be produced to include oxygen-containing functional groups on the surface of the carbon fiber. For solid supports which do not contain oxygen-containing functional groups or do not have the desired density of oxygen-containing functional groups, the solid support can be modified to include the oxygen-containing functional groups.

One method to modify the solid support to include oxygen-containing functional such as carboxyl, carbonyl, lactone, and hydroxyl, for example, may include oxidizing at least a portion of the solid support. The step of oxidizing can be carried out to any suitable extent. Without limitation, the carbon fiber may be oxidized to include about 0.01 wt. % to about 25 wt. % oxygen-containing functional groups. Alternatively, the solid support may be oxidized to include about 0.1 wt. % to about 1 wt. % oxygen-containing functional groups, about 1 wt. % to about 5 wt. % oxygen-containing functional groups, about 5 wt. % to about 10 wt. % oxygen-containing functional groups, about 10 wt. % to about 15 wt. % oxygen-containing functional groups, about 15 wt. % to about 20 wt. % oxygen-containing functional groups, about 20 wt. % to about 25 wt. % oxygen-containing functional groups, or any ranges therebetween. The degree of oxidation may be utilized to control the final concentration of polyamine dispersed on the carbonyl sulfide hydrolysis catalyst which may in turn directly affect the overall catalytic activity of the carbonyl sulfide hydrolysis catalyst.

Oxidation of the solid support may be achieved by submersing the solid support in an acid and allowing the acid to react with the solid support. Suitable acids may include mineral acids such as hydrochloric acid, nitric acid, phosphoric acid, sulfuric acid, boric acid, hydrofluoric acid, hydrobromic acid, perchloric acid, hydroiodic acid, fluoroantimonic acid, carborane acids, fluoroboric acid, fluorosulfuric acid, hydrogen fluoride, triflic acid, and perchloric acid for example organic acids such as acetic acid, formic acid, citric acid, oxalic acid, and tartaric acid, for example. In addition to, or alternatively to oxidation using acids, the oxidation step may also be performed using plasma treatment in oxygen atmosphere, gamma radiation treatment, electrochemical oxidation using an oxidant such as sodium hydroxide, ammonium hydrogen carbonate, ammonium carbonate, sulfuric acid, or nitric acid, or oxidation by potassium persulfate with sodium hydroxide or silver nitrate. The oxidation may be performed at any temperature in the range of about 0° C. to 150° C. Alternatively, the oxidation may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. Oxidation may be performed for any period of time suitable for achieving a desired concentration of oxygen-containing functional groups on the solid support. The time required to achieve a specified concentration of oxygen-containing functional groups may be dependent upon many factors including oxidation technique such as identity and concentration of the acid and temperature conditions selected in acid oxidation. In general, the oxidation may be carried out for a period of time ranging from about 1 hour to about 24 hours. Alternatively, the oxidation may be carried out in a time ranging from about 1 hour to about 3 hours, about 3 hours to about 6 hours, about 6 hours to about 9 hours, about 9 hours to about 12 hours, about 12 hours to about 15 hours, about 15 hours to about 18 hours, about 18 hours to about 21 hours, about 21 hours to about 24 hours, or any ranges therebetween. After oxidation by acid treatment, the oxidized solid support may optionally be washed using water or other solvent to remove excess acid. The oxidized solid support may be dried at elevated temperature after washing to remove water or solvent used in the washing step.

Once the carbonyl sulfide hydrolysis catalyst has been synthesized as described above, the carbonyl sulfide hydrolysis catalyst may be further processed by shaping the carbonyl sulfide hydrolysis catalyst into a desired shape. In some embodiments, the carbonyl sulfide hydrolysis catalyst can pelletized or otherwise made suitable for use in a packed bed application. Additionally, when the solid support is a fiber, the carbonyl sulfide hydrolysis catalyst will also be in the form of a catalytic fiber. Individual strands of the catalytic fiber may be drawn together and secured to form a catalytic fiber bundle. The catalytic carbon fiber bundle may be utilized in a reactor to form a reaction zone within a vessel. Additional processing of the carbonyl sulfide hydrolysis catalyst may include reducing the size of the fibers to produce a carbonyl sulfide hydrolysis catalyst suitable for fluidization, for example within a fluidized bed reactor.

Process streams in refineries, chemical plants, and manufacturing often contain unwanted contaminants such as carbonyl sulfide and hydrogen sulfide. Product specifications may call for the reduction and/or removal of these contaminants during the manufacturing process such that the product is on specification. It may be desirable to reduce the carbonyl sulfide content of process stream to produce a product stream with reduced carbonyl sulfide content.

There may be a wide variety of process streams which contain contaminants such as carbonyl sulfide and hydrogen sulfide that may be removed. While the present application may only disclose embodiments with regards to some specific hydrocarbon streams, the disclosure herein may be readily applied to other hydrocarbon streams and non-hydrocarbon process streams not specifically enumerated herein. The carbonyl sulfide and hydrogen sulfide treatment process described herein may be appropriate for treatment of any hydrocarbon feed including, but not limited to, hydrocarbons such as alkanes, alkenes, alkynes, and aromatics, for example. The hydrocarbons may comprise hydrocarbons of any chain length, for example, from about C₃ to about C₃₀, or greater, and may comprise any amount of branching. Some exemplary hydrocarbon feeds may include, but are not limited to, crude oil, propane, LPG, butane, light naphtha, isomerate, heavy naphtha, reformate, jet fuel, kerosene, diesel oil, hydro treated distillate, heavy vacuum gas oil, light vacuum gas oil, gas oil, coker gas oil, alkylates, fuel oils, fuel gas, natural gas, off gas, light cycle oils, and combinations thereof. Some non-limiting examples of hydrocarbon streams may include crude oil distillation unit streams such as light naphtha, heavy naphtha, jet fuel, and kerosene, fluidized catalytic cracker or reside catalytic cracker gasoline, natural gasoline from natural gas liquid fractionation, and gas condensates.

Methods of removing carbonyl sulfide and hydrogen sulfide may include contacting a stream comprising carbonyl sulfide, and optionally hydrogen sulfide, with water in the presence of the carbonyl sulfide hydrolysis catalyst described above. In some embodiments, the water may be from an aqueous hydrogen sulfide scavenger solution. The aqueous hydrogen sulfide scavenger solution generally comprises water and one or more hydrogen sulfide scavengers. At least a portion of the carbonyl sulfide is catalytically hydrolyzed by the carbonyl sulfide hydrolysis catalyst with water to produce hydrogen sulfide. In embodiments, the hydrogen sulfide may be further reacted with a hydrogen sulfide scavenger in the aqueous hydrogen sulfide scavenger solution or absorbed into the aqueous hydrogen sulfide scavenger solution, depending on the chemical identity of the hydrogen sulfide scavenger in the aqueous hydrogen sulfide scavenger solution. Another method for removing carbonyl sulfide and hydrogen sulfide may include contacting a stream comprising carbonyl sulfide, and optionally hydrogen sulfide, with an aqueous stream and hydrolyzing at least a portion of the carbonyl sulfide in the presence of a carbonyl sulfide hydrolysis catalyst to produce hydrogen sulfide. The hydrogen sulfide containing stream can then be contacted with a separate aqueous hydrogen sulfide scavenger solution and further reacted with the hydrogen sulfide scavenger in the aqueous hydrogen sulfide scavenger solution or absorbed into the aqueous hydrogen sulfide scavenger solution, depending on the chemical identity of the hydrogen sulfide scavenger in the aqueous hydrogen sulfide scavenger solution.

Suitable aqueous hydrogen sulfide scavenger solutions can include regenerative hydrogen sulfide scavengers and non-regenerative hydrogen sulfide scavengers. Some examples of hydrogen sulfide scavengers include, without limitation, aqueous caustic solutions such as aqueous metal hydroxide containing solutions, amines such as monoethanolamine (MEA), diethanolamine (DEA), N-methyldiethanolamine (MDEA), diisopropylamine, 2-(2-aminoethoxy)ethanolamine, triazine, MEA triazine solutions, ethylenedioxydimethanol solutions, oxazolidine derivative solutions, aldehyde solutions such as glyoxal, solid scavengers such as zinc carbonate, zinc oxide, or iron oxide in aqueous solution, metal carboxylates in aqueous solution, aqueous solutions of oxidizers such as sodium chlorite, sodium bromate, sodium nitrite, glycols such as ethylene glycol, and combinations thereof. In further embodiments, the amine may be in an aqueous solution. In embodiments where the aqueous hydrogen sulfide scavenger solution comprises a metal hydroxide, any suitable metal hydroxides may be used include Group I and Group II hydroxides such as NaOH, KOH, Ca(OH)₂, and Mg(OH)₂, for example. Hydrogen sulfide scavengers may be present in aqueous hydrogen sulfide scavenger solutions in any concentration or weight percent suitable for a particular application, generally from about 5 wt. % up to and including saturation.

In embodiments where the hydrogen sulfide scavenger includes a non-regenerative hydrogen sulfide scavenger, the hydrogen sulfide scavenger may react with the hydrogen sulfide to produce a hydrogen sulfide reaction product which irreversibly consumes the hydrogen sulfide scavenger. In embodiments where the hydrogen sulfide scavenger includes a regenerative hydrogen sulfide scavenger, the hydrogen sulfide scavenger may react with the hydrogen sulfide to form a hydrogen sulfide reaction product which can be reversibly reacted back to hydrogen sulfide and hydrogen sulfide scavenger. Some examples include a glyoxal-hydrogen sulfide adduct which can be reversibly broken into constituent glyoxal and hydrogen sulfide. Alternatively, hydrogen sulfide can be chemically absorbed into the aqueous hydrogen sulfide scavenger solution which can then be regenerated to form the constituent aqueous hydrogen sulfide scavenger solution and hydrogen sulfide.

In embodiments where the aqueous hydrogen sulfide scavenger solution comprises an aqueous caustic solution comprising a metal hydroxide, a reaction product of the hydrogen sulfide with caustic can include a hydrosulfide salt, and under certain process conditions, sodium sulfide and/or hydrates thereof. In embodiments where the aqueous hydrogen sulfide scavenger solution comprises sodium hydroxide, reaction products can include at least one of sodium hydrosulfide, sodium sulfide, or sodium sulfide hydrate. Once the hydrogen sulfide is reacted with the caustic, a “spent caustic” or “rich caustic” solution containing the water, residual hydroxide, and soluble reaction products may be generated. The spent caustic may be regenerated by any suitable means to form lean caustic, such as oxidative regeneration whereby oxygen or air is mixed with the spent caustic and contacted with a suitable catalyst to regenerate the aqueous caustic solution. The regenerated “lean caustic” can be recycled back to further react with additional hydrogen sulfide.

In addition to or in lieu of the above-mentioned hydrogen sulfide scavengers, additional scavengers such as triethylene glycol, diethylene glycol, monoethylene glycol, methanol, molecular sieves including zeolites, porous glass, activated carbon, montmorillonite, halloysite, silica gel, and mesoporous silica, and combinations thereof, may be used to remove hydrogen sulfide.

There may be a wide variety of process conditions suitable for hydrolysis of carbonyl sulfide to hydrogen sulfide. The particular process conditions may vary depending on the identify and composition of the process stream contaminated with carbonyl sulfide feed. For example, in hydrocarbons streams contaminated with carbonyl sulfide, operating pressure may be controlled to be slightly above the bubble point of the hydrocarbon stream to ensure liquid-phase operation. Operating temperature may also be selected based on the process stream with general conditions of temperature ranging from about 10° C. to about 100° C. Alternatively, from about 10° C. to about 20° C., about 20° C. to about 50° C., about 50° C. to about 80° C., 80° C. to about 100° C., or any ranges therebetween.

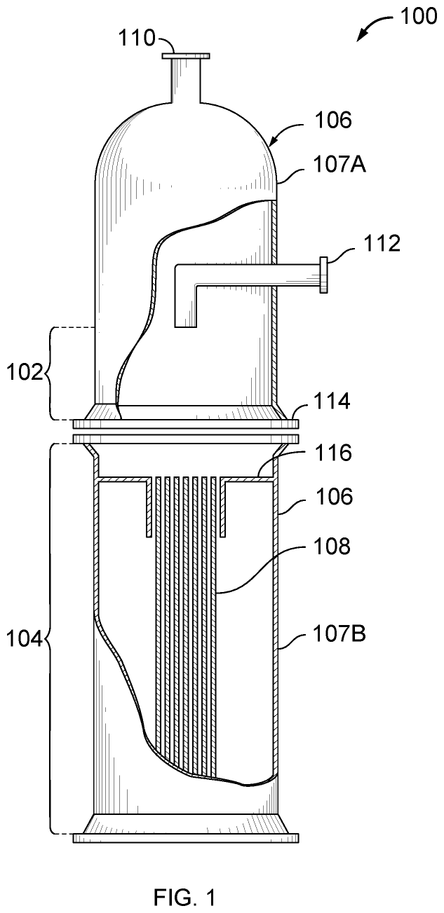

FIG. 1 illustrates, in schematic form, an embodiment of a fiber-bundle type liquid-liquid mass transfer device 100. Fiber-bundle type liquid-liquid mass transfer device 100 may comprise vessel 106 which may contain and/or otherwise support equipment and features required for liquid-liquid contacting. As illustrated, vessel 106 may comprise two halves 107a, 107b joined by flange 114 which may provide a mounting point to secure the two halves 107a, 107b of vessel 106 together. Alternatively, vessel 106 may comprise a single continuous vessel without flange 114 or may comprise a plurality of pieces joined by flanges or otherwise secured together. As illustrated, fiber-bundle type liquid-liquid mass transfer device 100 is oriented in a vertical direction. One of ordinary skill in the art will appreciate that fiber-bundle type liquid-liquid mass transfer device 100 may be oriented in any direction, such as, for example, horizontally, vertically, or any angle in-between. Vessel 106 may comprise various inlets configure to allow liquids to enter into vessel 106. Vessel 106 may comprise a first inlet 110 and a second inlet 112, for example. Although only two inlets are illustrated, one of ordinary skill in the art would understand that any number of inlets may be used for a particular application. Vessel 106 may further comprise contact zone 102 and extraction zone 104. Contact zone 102 may comprise various features such as plates, distributors, and nozzles which can promote mixing and distribution of liquids before the liquids enter extraction zone 104. Extraction zone 104 may comprise various features which may promote liquid-liquid contact to effectuate mass transfer, chemical reactions, or both.

In some embodiments, extraction zone 104 may comprise one or more catalytic fiber bundles 108 comprising a carbonyl sulfide removal catalyst as described above. Although only one fiber catalytic bundle 108 is illustrated, one of ordinary skill in the art will appreciate that any number of fiber bundles may be present. Additionally, without limitation, the catalytic fiber bundles may be arranged in series, parallel, series and parallel, or any other configuration. Catalytic fiber bundle 108 may comprise elongated fibers that extend from or below contact zone 102 through extraction zone 104. Catalytic fiber bundle 108 may promote contact between the liquids introduced into vessel 106 by allowing a first liquid to flow along individual fibers of fiber bundle 108 and a second liquid to flow between the individual fibers to facilitate contact between the first liquid and the second liquid. The catalytic fiber bundle 108 includes carbonyl sulfide removal catalyst which allows for carbonyl sulfide to be hydrolyzed by water to form hydrogen sulfide as described above where the intimate contact provided by the configuration of the fibers allows for a more complete reaction of the carbonyl sulfide. The hydrogen sulfide can then be further reacted with or absorbed into a hydrogen sulfide scavenger to reduce the amount of hydrogen sulfide in the first and second liquid at the end of the extraction zone 104.

Each of the embodiments described herein may generally operate by the same physical phenomena. Two liquids may be individually introduced into vessel 106 through first inlet 110 and second inlet 112 and flow through contact zone 102 into extraction zone 104. In some embodiments, a first liquid introduced through first inlet 110 may be relatively light, or less dense, than a second liquid introduced through second inlet 112. Mixing features present in contact zone 102 may promote mixing of the two immiscible liquids before the liquids flow into extraction zone 104. As one of ordinary skill in the art will appreciate, mixing of the two liquids may increase the effective surface area of extraction zone 104 which in turn may reduce the required length of extraction zone 104, decrease pressure drop across liquid-liquid mass transfer device 100, reduce material costs, reduce operations costs, and other benefits readily apparent to those of ordinary skill in the art. In some embodiments, fiber-bundle type liquid-liquid mass transfer device 100 may be used in carbonyl sulfide removal when at least one of the liquids introduced into fiber-bundle type liquid-liquid mass transfer device 100 includes carbonyl sulfide and the other liquid includes a hydrogen sulfide scavenger solution.

In an embodiment, fiber-bundle type liquid-liquid mass transfer device 100 may be used in a caustic treatment application whereby a hydrocarbon feed contaminated with carbonyl sulfide and an aqueous caustic solution such as a group I or group II metal hydroxide solution are introduced into fiber-bundle type liquid-liquid mass transfer device 100. The aqueous caustic solution may comprise water and a caustic agent such as sodium hydroxide, potassium hydroxide, or other compounds that release a hydroxide ion when added to water. The caustic treatment process may be appropriate for treatment of any hydrocarbon feed including, but not limited to, hydrocarbons such as alkanes, alkenes, alkynes, and aromatics, for example. The hydrocarbons may comprise hydrocarbons of any chain length, for example, from about C₃ to about C₃₀, or greater, and may comprise any amount of branching. Some exemplary hydrocarbon feeds may include, but are not limited to, crude oil, propane, LPG, butane, light naphtha, isomerate, heavy naphtha, reformate, jet fuel, kerosene, diesel oil, hydro treated distillate, heavy vacuum gas oil, light vacuum gas oil, gas oil, coker gas oil, alkylates, fuel oils, light cycle oils, and combinations thereof. The hydrocarbon feed and the aqueous caustic solution may be contacted in extraction zone 104 within catalytic fiber bundle 108 such that carbonyl sulfide in the hydrocarbon feed react with the water in the aqueous caustic solution to produce hydrogen sulfide. The hydrogen sulfide can then further react with hydroxide from the aqueous caustic solution to produce a sulfur containing reaction product.

Another application of fiber-bundle type liquid-liquid mass transfer device 100 may be in an amine treatment application whereby a hydrocarbon feed and an aqueous or liquid amine feed are introduced into fiber-bundle type liquid-liquid mass transfer device 100. The hydrocarbon feed and the amine feed may be contacted in extraction zone 104 within catalytic fiber bundle 108 such that carbonyl sulfide in the hydrocarbon feed reacts as described above. The hydrogen sulfide can then further react with amine from the amine feed to produce a sulfur containing reaction product. In an amine application, the amine feed may optionally include water and any of the amines disclosed above including diethanolamine, monoethanolamine, methyldiethanolamine, diisopropanolamine, aminoethoxyethanol, and diglycolamine, for example.

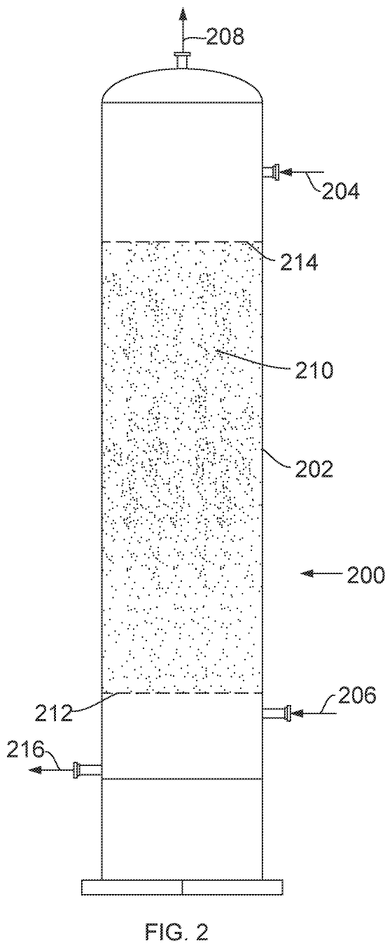

FIG. 2 illustrates, in schematic form, an embodiment of a packed tower type liquid-liquid mass transfer device 200. Packed tower type liquid-liquid mass transfer device 200 may include vessel 202 which may contain and/or otherwise support equipment and features required for liquid-liquid contacting. As illustrated, vessel 202 may comprise a first inlet 204, a second inlet 206, a first outlet 208, and a second outlet 216, for example. Packed bed 210 may be disposed in vessel 202 and may be supported by lower support 212 and upper support 214. Packed bed 210 may comprise any of the carbonyl sulfide removal catalysts previously described.

Packed bed 210 may promote contact between the liquids introduced into vessel 202 by allowing a first liquid to flow along individual packing elements within packed bed 210 and a second liquid to flow between the individual packing elements to facilitate contact between the first liquid and the second liquid. Packed bed 210 comprising carbonyl sulfide removal catalyst allows for carbonyl sulfide to be hydrolyzed by water to form hydrogen sulfide as described above where the intimate contact provided by the configuration of the packed bed which allows for a more complete reaction of the carbonyl sulfide. The hydrogen sulfide can then be further reacted with or absorbed into a hydrogen sulfide scavenger to reduce the amount of hydrogen sulfide in the first and second liquid leaving first outlet 208.

In some embodiments, the two liquids may be individually introduced into vessel 202, whereby the first liquid is introduced through first inlet 204 and the second liquid is introduced into second inlet 206. The first liquid enters packed bed 210 from above and the second liquid enters packed bed 210 from below. The first and second liquid flow counter-currently through packed bed 210. In some embodiments, a first liquid introduced through first inlet 204 may be relatively heavier, or more dense, than a second liquid introduced through second inlet 206. In some embodiments, packed tower type liquid-liquid mass transfer device 200 may be used in carbonyl sulfide removal when at least one of the liquids introduced into packed tower type liquid-liquid mass transfer device 200 includes carbonyl sulfide and the other liquid includes a hydrogen sulfide scavenger solution.

In an embodiment, packed tower type liquid-liquid mass transfer device 200 may be used in a caustic treatment application whereby a hydrocarbon feed contaminated with carbonyl sulfide and an aqueous caustic solution such as a group I or group II metal hydroxide solution are introduced into packed tower type liquid-liquid mass transfer device 200. In such embodiments, the aqueous caustic solution is introduced into first inlet 204 and the hydrocarbon feed is introduced into second inlet 206. The aqueous caustic solution may comprise water and a caustic agent such as sodium hydroxide, potassium hydroxide, or other compounds that release a hydroxide ion when added to water. The caustic treatment process may be appropriate for treatment of any hydrocarbon feed including, but not limited to, hydrocarbons such as alkanes, alkenes, alkynes, and aromatics, for example. The hydrocarbons may comprise hydrocarbons of any chain length, for example, from about C₃ to about C₃₀, or greater, and may comprise any amount of branching. Some exemplary hydrocarbon feeds may include, but are not limited to, crude oil, propane, LPG, butane, light naphtha, isomerate, heavy naphtha, reformate, jet fuel, kerosene, diesel oil, hydro treated distillate, heavy vacuum gas oil, light vacuum gas oil, gas oil, coker gas oil, alkylates, fuel oils, light cycle oils, and combinations thereof. The hydrocarbon feed and the aqueous caustic solution may be contacted in packed bed 210 such that carbonyl sulfide in the hydrocarbon react with the water in the aqueous caustic solution to produce hydrogen sulfide. The hydrogen sulfide can then further react with hydroxide from the aqueous caustic solution to produce a sulfur containing reaction product. The aqueous caustic solution flows down though packed bed 210 and exits liquid-liquid mass transfer device 200 though second outlet 216. The hydrocarbon feed flows up though packed bed 210 and exits liquid-liquid mass transfer device 200 though first outlet 208.

Another application of fiber-bundle type packed tower type liquid-liquid mass transfer device 200 may be in an amine treatment application whereby a hydrocarbon feed and an aqueous or liquid amine feed are introduced into packed tower type liquid-liquid mass transfer device 200. In such embodiments, the amine feed is introduced into first inlet 204 and the hydrocarbon feed is introduced into second inlet 206. The hydrocarbon feed and the amine feed may be contacted in packed bed 210 such that carbonyl sulfide is reacted as described above. The hydrogen sulfide can then further react with amine from the amine feed to produce a sulfur containing reaction product. In an amine application, the amine feed may optionally include water and any of the amines disclosed above including diethanolamine, monoethanolamine, methyldiethanolamine, diisopropanolamine, aminoethoxyethanol, and diglycolamine. The amine feed flows down though packed bed 210 and exits liquid-liquid mass transfer device 200 though second outlet 216. The hydrocarbon feed flows up though packed bed 210 and exits liquid-liquid mass transfer device 200 though first outlet 208.

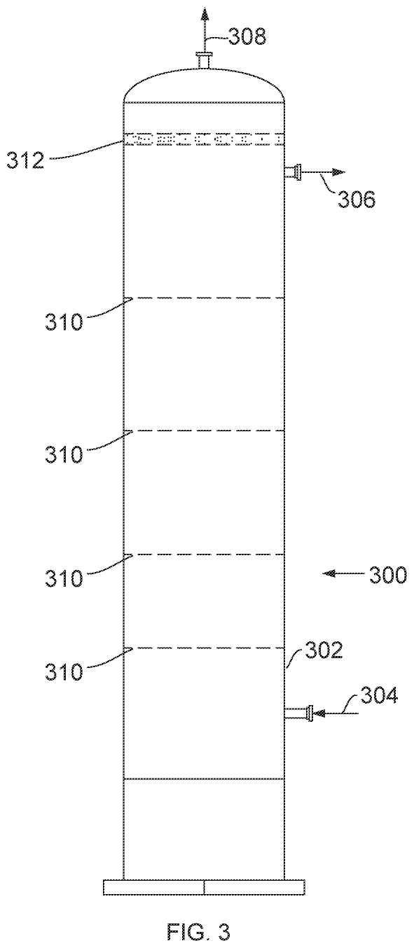

FIG. 3 illustrates, in schematic form, an embodiment of a distillation column 300. Distillation column may include vessel 302 which may contain and/or otherwise support equipment and features required for distillation. As illustrated, vessel 202 may comprise a first inlet 304, a first outlet 306, and a second outlet 308, for example. In embodiments, distillation column 300 may include trays 310 to support distillation. Demister pad 312 may be disposed in vessel 302.

Accordingly, the present disclosure may provide methods, systems, and apparatus that may relate to carbonyl sulfide removal catalysts and liquid-liquid contactors comprising a carbonyl sulfide removal catalyst. The methods, systems, and apparatus may include any of the various features disclosed herein, including one or more of the following statements.

Statement 1. A method comprising: contacting a feed stream comprising carbonyl sulfide with an aqueous stream comprising water in the presence of a carbonyl sulfide hydrolysis catalyst, wherein the carbonyl sulfide hydrolysis catalyst comprises a solid support and a polyamine covalently bonded to the solid support; and hydrolyzing at least a portion of the carbonyl sulfide to produce at least hydrogen sulfide.

Statement 2. The method of statement 1 wherein the solid support comprises at least one support selected from the group consisting of activated carbon fiber, carbon fiber, nylon, silica, titanium dioxide, aluminum oxide, and combinations thereof.

Statement 3. The method of statement 2 wherein the solid support is in the form of a fiber, wherein the fiber comprises at least one of a solid fiber or a hollow fiber.

Statement 4. The method of any of statements 1-3 wherein the polyamine has a carbon number in a range of C2-C20, and the wherein the polyamine comprise at least one of a primary or secondary polyamine that is linear, branched or cyclic.

Statement 5. The method of any of statements 1-4 wherein the polyamine comprises at least one amine selected from the group consisting of ethylenediamine, propane-1,3-diamine, butane-1,4-diamine, pentane-1,5-diamine, hexamethylenediamine, diethylenetriamine, benzene-1,3,5-triamine, polyethyleneimine (PEI), and combinations thereof.

Statement 6. The method of any of statements 1-5 wherein the aqueous stream further comprises at least one hydrogen sulfide scavenger selected from the group consisting of a metal hydroxide, an amine, a metal carbonate, a metal oxide, an aldehyde, a glycol, an oxidizer and combinations thereof.

Statement 7. The method of any of statements 1-6 wherein the aqueous stream further comprises at least one metal hydroxide selected from the group consisting of sodium hydroxide, potassium hydroxide, calcium hydroxide, magnesium hydroxide, and combinations thereof and wherein the at least one metal hydroxide is reacted with at least a portion of the hydrogen sulfide to produce at least a corresponding metal hydrosulfide.

Statement 8. The method of any of statements 1-7 wherein the carbonyl sulfide hydrolysis catalyst is present in a packed bed.

Statement 9. The method of any of statements 1-8 wherein the carbonyl sulfide hydrolysis catalyst is present in a catalytic fiber bundle.

Statement 10. A method comprising: introducing carbonyl sulfide and an aqueous liquid into a vessel comprising a carbonyl sulfide hydrolysis catalyst; and hydrolyzing at least a portion of the carbonyl sulfide to produce at least hydrogen sulfide; wherein the carbonyl sulfide hydrolysis catalyst comprises a solid support and a polyamine covalently bonded to the solid support and wherein the vessel comprises at least one of a distillation column, a contacting tower, or a fiber bundle type liquid-liquid contactor.

Statement 11. The method of statement 10 wherein the vessel comprises the distillation column and wherein the carbonyl sulfide hydrolysis catalyst is present in a pad disposed within the distillation column.

Statement 12. The method of any of statements 10-11 wherein the vessel comprises the contacting tower and wherein the carbonyl sulfide hydrolysis catalyst is present in a packed bed disposed within the contacting tower.

Statement 13. The method of any of statements 10-12 wherein the vessel comprises the fiber bundle type liquid-liquid contactor and wherein the wherein the carbonyl sulfide hydrolysis catalyst is present in a catalytic fiber bundle.

Statement 14. The method of any of statements 10-13 wherein the polyamine comprises at least one of a primary or secondary, linear, branched, or cyclic polyamine with a carbon number in a range of from C2-C20, wherein the polyamine comprises at least one amine selected from the group consisting of ethylenediamine, propane-1,3-diamine, butane-1,4-diamine, pentane-1,5-diamine, hexamethylenediamine, diethylenetriamine, benzene-1,3,5-triamine, polyethyleneimine (PEI) and combinations thereof, and wherein the solid support comprises at least one support selected from the group consisting of activated carbon fiber, carbon fiber, nylon, silica, titanium dioxide, aluminum oxide, and combinations thereof.

Statement 15. A method of producing a carbonyl sulfide hydrolysis catalyst comprising: providing a solid support comprising an oxygen containing functional group; mixing the solid support with a polyamine; and reacting at least a portion of the polyamine with the solid support to form a covalent bond between the polyamine and the solid support, thereby forming the carbonyl sulfide hydrolysis catalyst.

Statement 16. The method of statement 15 wherein the solid support comprises at least one support selected from the group consisting of activated carbon fiber, carbon fiber, nylon, silica, titanium dioxide, aluminum oxide, and combinations thereof.

Statement 17. The method of any of statements 15-16 wherein the reacting at least the portion of the polyamine with the solid support is carried out in a solvent at a temperature in a range of about 100° C. to about 200° C.

Statement 18. The method of any of statements 15-17 further comprising reacting the solid support with a chlorinating agent to produce a solid support comprising acyl chloride, wherein the reacting at least the portion of the polyamine with the solid support comprises forming an amide bond between the polyamine and the acyl chloride.

Statement 19. The method of any of statements 15-18 further comprising reacting the solid support with a coupling agent selected from carbodiimide, benzotriazole, or combinations thereof to produce a functionalized solid support, wherein the reacting at least the portion of the polyamine with the solid support comprises forming an amide bond between the polyamine and the functionalized solid support.

Statement 20. The method of any of statements 15-19 further comprising mixing the solid support and the polyamine with an enzyme capable of catalyzing an amide bond formation, wherein the reacting at least the portion of the polyamine with the solid support comprises reacting in the presence of the enzyme to form an amide bond between the polyamine and the solid support.

### Examples

To facilitate a better understanding of the present disclosure, the following illustrative examples of some of the embodiments are given. In no way should such examples be read to limit, or to define, the scope of the disclosure.

In this Example, a carbonyl sulfide hydrolysis catalyst was prepared and evaluated. First, 8.42 grams of virgin carbon fiber was oxidized in 200 mL of 70% nitric acid at 80° C. for 6 hours to produce oxidized carbon fiber. The oxidized carbon fiber was washed with DI water and heated in ethylenediamine at 105° C. for a period of 7 hours to produce the carbonyl sulfide hydrolysis catalyst. The carbonyl sulfide hydrolysis catalyst was washed with DI water and dried in an oven at 60° C. until dry.

The carbonyl sulfide hydrolysis catalyst prepared by the above method was evaluated for carbonyl sulfide removal performance. A test hydrocarbon was prepared by dissolving 500 ppm COS (as elemental sulfur) in heptane. Shake tests were performed with 150 mL of test hydrocarbon, 30 mL of 7 wt. % NaOH solution, and 3 grams of the carbonyl sulfide hydrolysis catalyst. The materials were placed in a container, capped, and mixed vigorously for 15 minutes at 38° C. The remaining COS (as elemental sulfur) was analyzed. It was observed that that COS removal ranged from 90% to 94% in the tests.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method comprising:
contacting a feed stream comprising carbonyl sulfide with an aqueous stream comprising water in the presence of a carbonyl sulfide hydrolysis catalyst, wherein the carbonyl sulfide hydrolysis catalyst comprises a solid support and a polyamine covalently bonded to the solid support; and
hydrolyzing at least a portion of the carbonyl sulfide to produce at least hydrogen sulfide.

2. The method of claim 1 wherein the solid support comprises at least one support selected from the group consisting of activated carbon fiber, carbon fiber, nylon, silica, titanium dioxide, aluminum oxide, and combinations thereof.

3. The method of claim 2 wherein the solid support is in the form of a fiber, wherein the fiber comprises at least one of a solid fiber or a hollow fiber.

4. The method of claim 1 wherein the polyamine has a carbon number in a range of C2-C20, and the wherein the polyamine comprise at least one of a primary or secondary polyamine that is linear, branched or cyclic.

5. The method of claim 1 wherein the polyamine comprises at least one amine selected from the group consisting of ethylenediamine, propane-1,3-diamine, butane-1,4-diamine, pentane-1,5-diamine, hexamethylenediamine, diethylenetriamine, benzene-1,3,5-triamine, polyethyleneimine (PEI), and combinations thereof.

6. The method of claim 1 wherein the aqueous stream further comprises at least one hydrogen sulfide scavenger selected from the group consisting of a metal hydroxide, an amine, a metal carbonate, a metal oxide, an aldehyde, a glycol, an oxidizer and combinations thereof.

7. The method of claim 1 wherein the aqueous stream further comprises at least one metal hydroxide selected from the group consisting of sodium hydroxide, potassium hydroxide, calcium hydroxide, magnesium hydroxide, and combinations thereof, and wherein the at least one metal hydroxide is reacted with at least a portion of the hydrogen sulfide to produce at least a corresponding metal hydrosulfide.

8. The method of claim 1 wherein the carbonyl sulfide hydrolysis catalyst is present in a packed bed.

9. The method of claim 1 wherein the carbonyl sulfide hydrolysis catalyst is present in a catalytic fiber bundle.

10. A method comprising:
introducing carbonyl sulfide and an aqueous liquid into a vessel comprising a carbonyl sulfide hydrolysis catalyst; and
hydrolyzing at least a portion of the carbonyl sulfide to produce at least hydrogen sulfide;
wherein the carbonyl sulfide hydrolysis catalyst comprises a solid support and a polyamine covalently bonded to the solid support and wherein the vessel comprises at least one of a distillation column, a contacting tower, or a fiber bundle type liquid-liquid contactor.

11. The method of claim 10 wherein the vessel comprises the distillation column and wherein the carbonyl sulfide hydrolysis catalyst is present in a pad disposed within the distillation column.

12. The method of claim 10 wherein the vessel comprises the contacting tower and wherein the carbonyl sulfide hydrolysis catalyst is present in a packed bed disposed within the contacting tower.

13. The method of claim 10 wherein the vessel comprises the fiber bundle type liquid-liquid contactor and wherein the wherein the carbonyl sulfide hydrolysis catalyst is present in a catalytic fiber bundle.

14. The apparatus of claim 10 wherein the polyamine comprises at least one of a primary or secondary, linear, branched, or cyclic polyamine with a carbon number in a range of from C2-C20, wherein the polyamine comprises at least one amine selected from the group consisting of ethylenediamine, propane-1,3-diamine, butane-1,4-diamine, pentane-1,5-diamine, hexamethylenediamine, diethylenetriamine, benzene-1,3,5-triamine, polyethyleneimine (PEI) and combinations thereof, and wherein the solid support comprises at least one support selected from the group consisting of activated carbon fiber, carbon fiber, nylon, silica, titanium dioxide, aluminum oxide, and combinations thereof.

15. A method of producing a carbonyl sulfide hydrolysis catalyst comprising:
providing a solid support comprising an oxygen containing functional group;
mixing the solid support with a polyamine; and
reacting at least a portion of the polyamine with the solid support to form a covalent bond between the polyamine and the solid support, thereby forming the carbonyl sulfide hydrolysis catalyst.

16. The method of claim 15 wherein the solid support comprises at least one support selected from the group consisting of activated carbon fiber, carbon fiber, nylon, silica, titanium dioxide, aluminum oxide, and combinations thereof.

17. The method of claim 15 wherein the reacting at least the portion of the polyamine with the solid support is carried out in a solvent at a temperature in a range of about 100° C. to about 200° C.

18. The method of claim 15 further comprising reacting the solid support with a chlorinating agent to produce a solid support comprising acyl chloride, wherein the reacting at least the portion of the polyamine with the solid support comprises forming an amide bond between the polyamine and the acyl chloride.

19. The method of claim 15 further comprising reacting the solid support with a coupling agent selected from carbodiimide, benzotriazole, or combinations thereof to produce a functionalized solid support, wherein the reacting at least the portion of the polyamine with the solid support comprises forming an amide bond between the polyamine and the functionalized solid support.

20. The method of claim 15 further comprising mixing the solid support and the polyamine with an enzyme capable of catalyzing an amide bond formation, wherein the reacting at least the portion of the polyamine with the solid support comprises reacting in the presence of the enzyme to form an amide bond between the polyamine and the solid support.
